(19) United States
(12) Patent Application Publication
(10) Pub. No.: US 2010/0124982 A1
(43) Pub. Date: May 20, 2010

(54) GAMING MACHINE AND DISPLAY DEVICE

(76) Inventors: Scott Monroe Stewart, Las Vegas, NV (US); Philip Jeffery Anderson, Las Vegas, NV (US); Colin Fong, Penshurst (AU)

Correspondence Address: MCANDREWS HELD & MALLOY, LTD, 500 WEST MADISON STREET, SUITE 3400, CHICAGO, IL, 60661, US

(21) Appl. No.: 12/576,051

(22) Filed: Oct. 8, 2009

Related U.S. Application Data
(60) Provisional application No. 61/103,846, filed on Oct. 8, 2008.
(60) Provisional application No. 61/118,886, filed on Dec. 1, 2008.

(51) Int. Cl. A63F 9/24; A63F 13/00; A63B 71/00

(52) U.S. Cl. 463/20; 463/30; 273/142 A

(57) ABSTRACT

A gaming machine (10) is provided that comprises a mechanically operable game component (703) and a video operable game component that is provided on a display screen (702) of a display device (701). The display screen (702) overlies the mechanically operable game component (703) and is transparent over the whole of an active area of the display screen (702) and wherein the whole of that area is useable to display the video game thereon.

A shutter (705) is positioned between the display screen (702) and the mechanically operable game component (703) and is changeable between closed and open viewing states. In the closed state the mechanically operable game component (703) cannot be viewed by a player, and in an open viewing state the mechanically operable game component (703) can be viewed by the player. A display device (701) incorporating the above features is also provided.

### RELATED APPLICATIONS

This application claims priority to U.S. Provisional Patent Application No. 61/118,886, having a filing date of Dec. 1, 2008, and U.S. Provisional Patent Application No. 61/103,846, filed Oct. 8, 2008, both of which are incorporated herein by reference in their entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The invention relates to gaming machines and display devices. In the past, gaming machines have been proposed that provide a combination of a mechanically operable game component and a video operable game component. In these gaming machines, the video operable game component includes a display screen which overlays the mechanical operable game component such as a slot machine electro-mechanical stepper reel. The display screen can be made transparent so that in one mode of operation a video game can be played on the video screen, and in another mode of operation where the screen is made transparent, the underlying mechanically operable game component can be viewed and played. Gaming machines of the above type use a video screen which typically comprises a liquid crystal display (LCD). The LCD has at least one transparent portion that defines a window through which mechanical reel or reels of a mechanical game component can be observed. The transparent window is provided by removing a reflective back layer and any other back layers from a typical LCD display panel over the required window(s) area. Typically, discreet window areas are provided which coincide with the underlying mechanical game component such as reels of a reel game, e.g. window for viewing the reels. The display screen can then be used for a video game component in one mode of operation, and then when switched to another mode, the mechanical game component can be used, so the player may view the underlying reels of the mechanical game component through the windows and play a game using the mechanical game component. A problem with the above proposal is the video game component cannot present a high contrast image due to transmission of light from the underlying reels or from light within the cabinet of the gaming machine. In addition, there is a problem in presenting the video game component in the window areas where the mechanical reels are provided because there is no longer a required backlight over these areas.

The present invention attempts to address these issues.

### BRIEF SUMMARY OF THE INVENTION

According to one aspect of the invention there is provided a gaming machine, comprising:
a gaming machine, comprising:
a mechanically operable game component and a video operable game component, at least said video operable game component being operable by a processor in response to program code executed by said processor to provide a video game on a display screen of the said video operable game component,
said display screen overlaying said mechanically operable game component, being transparent over a whole of an active area of said display screen, and wherein the whole of the active area of said display screen is useable to display the video game thereon,
a shutter positioned between said display screen and said mechanically operable game component, said shutter being changeable between closed and open viewing states, and wherein in a closed viewing state said mechanically operable game component cannot be viewed by a player through said display screen, and wherein in an open viewing state said mechanically operable game component can be viewed by a player through said display screen.

In a further example, the gaming machine comprises a reel framing curtain between said display screen and said shutter and operable when said shutter is in an open viewable state to enable player viewing of intended viewable parts of the mechanically operable game component and to inhibit player viewing of parts not intended to be viewed.

In a further example, said shutter has multiple areas coinciding with the intended viewable parts of the mechanically operable game component and wherein said multiple areas are selectively changeable between closed and open viewing states to selectively enable required ones or required parts of each of the intended viewable parts to be not viewed or to be viewed by a player.

In a further example said shutter has an area at least as large as and of the same dimensions as the whole of the active area of the display screen and positioned to coincide therewith.

In accordance with another aspect of the invention there is provided a display device for a gaming machine, said display device comprising:
a video operable game component, being operable from a processor in response to program code executable by said processor to provide a video game on a display screen thereof,
said display screen being for overlaying a mechanically operable game component and being transparent over a whole of the active area of said display screen and wherein the whole of the active area of said display screen is useable to display the video game thereon,
a shutter for positioning between said display screen and said mechanically operable game component, said shutter being changeable between closed and open viewing states, and wherein, in use, in a closed viewing state said mechanically operable game component cannot be viewed by a player through said display screen, and wherein in an open viewing state said mechanically operable game component can be viewed by a player through said display screen.

In accordance with another aspect of the invention there is provided a gaming machine comprising:
a first display configured to display images for the play of a game;
a second display overlaying at least a portion of said first display, said second display including a video display component configured to display images for the play of the game and a shutter component, said video display component and shutter component being operable between a first condition where said second display is substantially transparent for viewing of said first display and the images displayed thereat and a second condition where said shutter component is substantially opaque to viewing of at least a portion of said first display; and
a processor to control the first and second displays to display for viewing images of said first display when said second display is in said first condition or images of said second display when said second display is in said second condition.

### BRIEF DESCRIPTION OF SEVERAL VIEWS OF THE DRAWINGS

In order that the invention can be more clearly ascertained examples of embodiments of the invention will now be described with reference to the accompanying drawings wherein:

FIG. 1 is a block circuit diagram illustrating components for a known gaming machine;

FIG. 2 is a perspective view of a known gaming machine;

FIG. 3 is a block circuit diagram of the operative components of the gaming machine of FIG. 2;

FIG. 4 is a block circuit diagram of a memory of the gaming machine of FIG. 2;

FIG. 5 is a block schematic diagram of functional components of the gaming machine of FIG. 2;

FIG. 6 is a block schematic diagram of components of a display device of the gaming machine of FIG. 2;

FIG. 7 is a diagrammatic side elevational view of a display device and an underlying mechanical game component in the form of spinning reels according to one example of an embodiment of the invention;

FIG. 8 is a view similar to FIG. 7 but showing another example of an embodiment;

FIG. 9 is a conceptual diagram showing various layers forming part of the display device in the example of FIG. 7, and

FIG. 10 is a diagram similar to that in FIGS. 7 and 8 showing a further example of an embodiment.

### DETAILED DESCRIPTION OF THE INVENTION

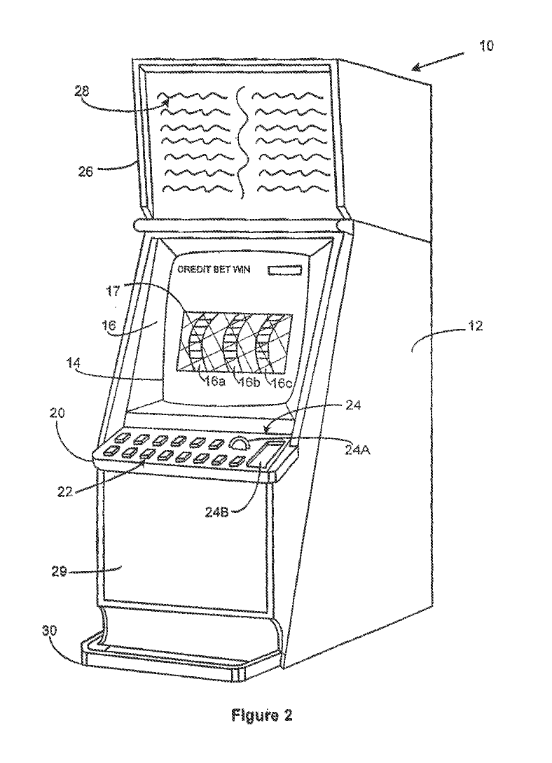

Referring to FIG. 2 of the drawings, there is shown a gaming machine having a first display and a second display. In one embodiment the gaming machine includes a mechanical game component as a first display that, in this example, has a plurality of electro-mechanical stepper reels 16a, 16b and 16c of a reel game. In the embodiment, each reel 16 has at least one stop position so that an image or indicia can be viewed to enable a reel game to be played in a known manner. By image or indicia what is meant are symbols, blanks or other graphical representations for playing the game of the gaming machine. The gaming machine also includes a second display overlying the first display which in this case comprises a video operable game component. This gaming machine allows play on the display device, and by making a window of the screen of the video operable game component (i.e. first display) transparent or semi transparent, the player can view through the window in the screen and see the reels of the mechanical game component, and can play the mechanical game component (i.e. the second display) in a normal known manner.

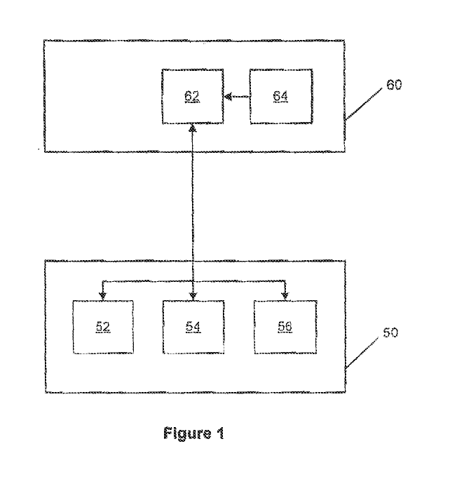

A gaming machine as depicted in FIG. 1 has several functional components. At the broadest level, the components are a player interface 50 and a game controller 60. The player interface is arranged to enable interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions. The credit mechanism 52 may be, for example, a bill acceptor which is configured to receive, validate and credit a cash amount to a credit meter for the game, as is known in the art. In the embodiments at least one display of the gaming machine is provided by one or more display devices in the form of a video gaming component and a mechanical game component that in this example has reel assemblies which include mechanical reels as described in further detail below.

The game controller 60 is in data communication with the player interface and typically includes a processor 62 that processes the game play instructions for both the video game component and the mechanical game component in accordance with game play rules, and outputs game play outcome data to the display 54. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

An example of the external physical form of a gaming machine 10 is illustrated in FIG. 2. The gaming machine 10 includes a housing in the form of cabinet 12 having a transparent panel 14 such as of glass or acrylic or similar with a viewing window 16 that enables the second display 17 (shown cross hatched) of the video game component to be viewed and to enable the mechanical game component reels of the first display to be viewed when the second display 17 is made transparent. The transparent panel 14 may be a “touch screen” to provide an input device to the game play mechanism 56 to permit the user to interact with the game play. In other embodiments, different numbers of reels are provided. A mid-trim 20 of the gaming machine 10 houses components of the interface 50 embodied as a bank of buttons 22 for enabling a player to interact with the gaming machine, in particular during game play. The mid-trim 20 also houses a credit mechanism 52 shown as a credit input mechanism 24 which in this example includes a coin input chute 24A and a bill acceptor 24B. Other credit input mechanisms may also be employed, for example, a card reader for reading a smart card, debit card or credit card. A reading device (not shown) may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the cabinet 12. A coin tray 30 is mounted beneath the front panel 29 for dispensing cash payouts from the gaming machine 10.

The top box 26 may also include an electronic display, for example a video display unit, particularly a cathode ray tube screen device. Alternatively, the top box display 26 may be a liquid crystal display, plasma screen, or any other suitable video display unit.

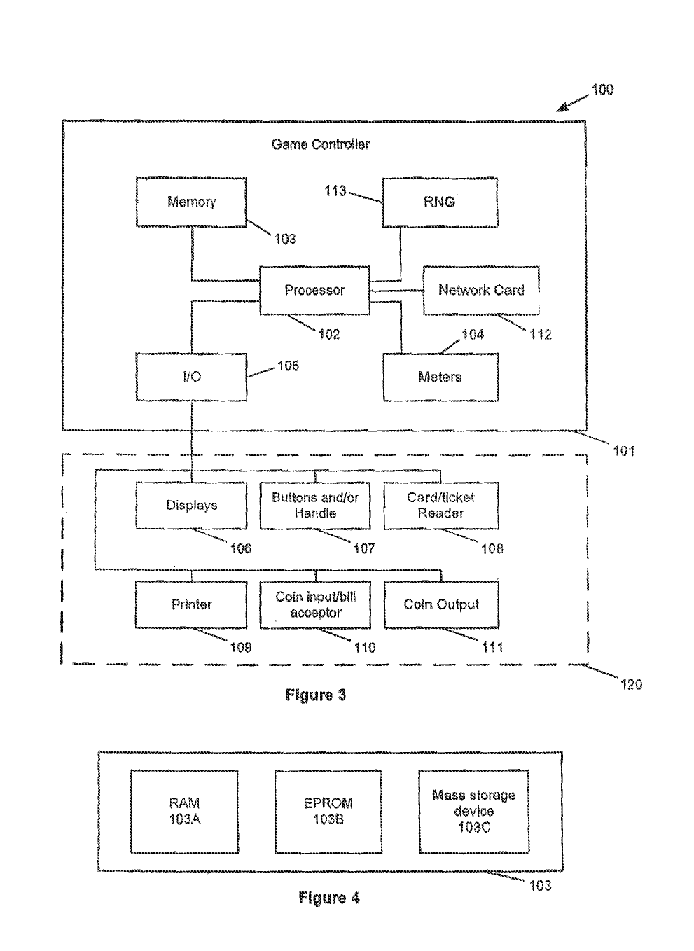

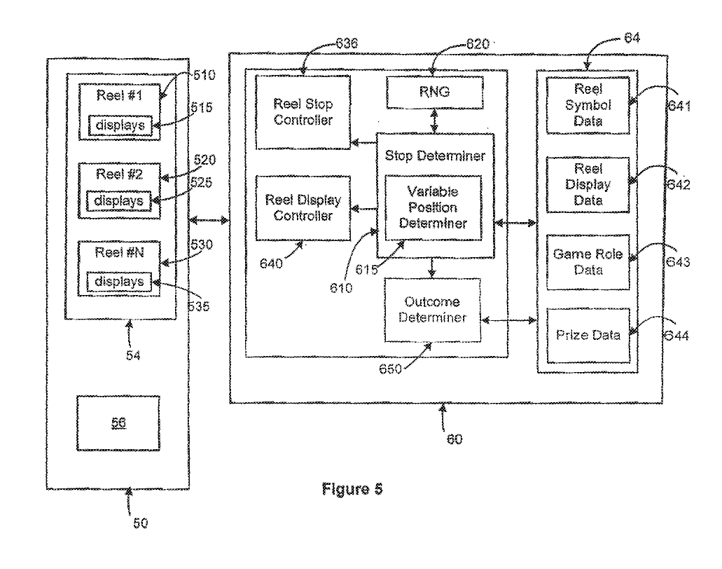

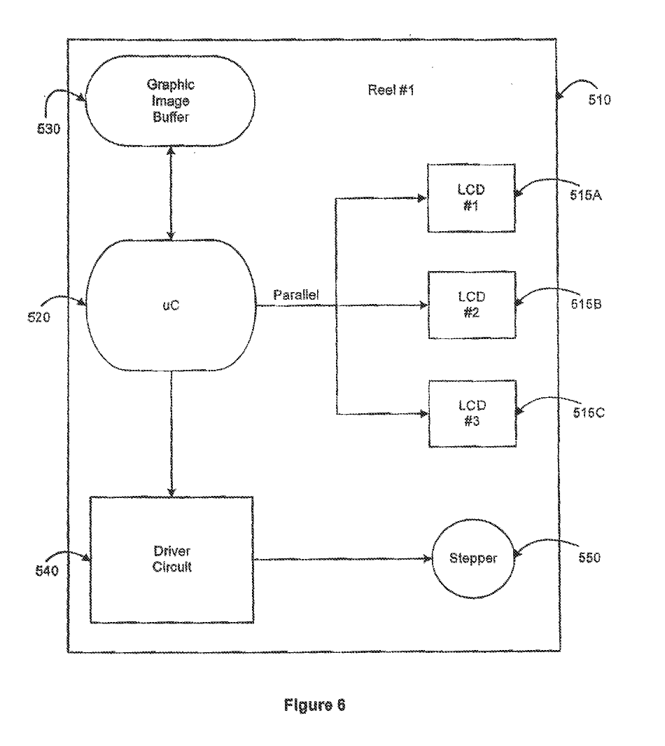

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 include one or more displays 106, buttons and/or handle 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card 112 may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The first display may be embodied as reels 16a-c of the mechanical game component are preferably driven by stepper motors which are well known in the art. The stepper motors allow the mechanical reels to be moved through a series of incrementally-spaced positions, e.g. 22 stops, and to be stopped at a desired position. In this way, the mechanical reels can be stopped at any one of a plurality of stop positions as determined by the processor 102. In the prior art, each of these stop positions corresponds to a symbol or indicia position, which can include blank positions (reel positions where there is no symbol). That is, a reel strip of printed symbols or indicia is affixed to the outer periphery of the reel. In most stepper machines of the prior art, a processor in combination with a random mechanism, such as a random number generator, randomly selects stop positions for each of plurality of reels (for example 3 to 5 reels) and the result is determined by the processor and random number generator based on these stopping positions. The randomly selected positions of the reels 16a-c, when stopped, present to the player a plurality of images, in this case, symbols or blanks resulting in one or more outcomes for the play of the game. A variation on such a system is described in U.S. Pat. No. 4,448,419 to Telnaes where there is a virtual expansion of a reel by mapping at least some actual physical stop positions to more than one possible outcome thereby changing the odds of particular outcomes.

The reels 16a-c may each display, for example, three symbols for viewing resulting in a 3×3 matrix of symbols displayed. The gaming machine may have one or more pay lines which, as is known in the art, can be wagered upon by the player. Depending upon the symbol combinations aligning with each enabled pay lines, the player has either a winning or losing outcome. For any winning outcomes the player is entitled to an award or prize.

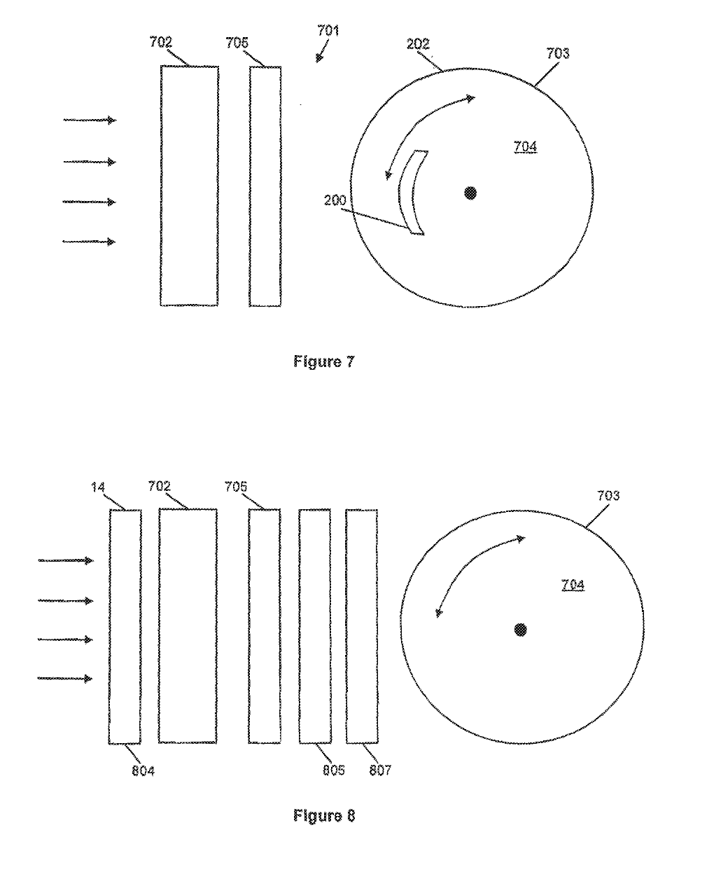

According to one embodiment of the present invention each reel 16a-c has backlighting. With reference to FIG. 7, each reel 16a-c has one or more lights 200 positioned to illuminate the reel strips 202. The lights 200 are controllable by the controller 100 at least between an ON state, where they backlight the reels 16a-c and an OFF state.

Referring now to FIG. 7 there is shown an example of a display device of an example of an embodiment of the invention which includes a first display 703 embodied as the electro-mechanical stepper reels 704 (in this example) and a second display 701 for a video game component. The first display 703 is controlled by the controller 100 to, upon acceptance of a wager and prompting of play of the gaming machine 10, randomly select and display images in the form of slot machine symbols for the play of the game. For example, the player may make a wager to enable five pay lines and prompt play whereupon the controller 100 randomly selects positions for each reel 704, spins and stops the reels 704 to present game symbols defining winning or losing outcomes for play of a base game. The second display screen 701 overlays the first display 703. The second display 701 includes a video display component 702, in this example, comprised of an LCD display configure to display images for the play of the game. For example, the second display 701 may be controlled by the controller 100 to display images associated with a bonus feature of the game. If the player obtains a qualifying outcome from the base game the player may be entitled to play a bonus game utilizing the images of the second display 701. The second display 701 also includes a shutter component 705 controllable by the controller. The shutter component 705 is also an LCD mated to the video component 702 for purposes of which will become evident.

The controller 100 is configured to control at least portions of the second display 701 between first and second conditions. In a first condition the video and shutter components 702, 705 are controlled to a substantially transparent mode. In this mode the crystals of the LCD displays of the video and shutter components 702, 705 are energized to pass light there through. Since the reels 704 are lighted by the lights 200 the reels 704 and the images presented by them are viewable through the portions of the second display 701 so configured. In a second condition at least portions of the shutter component 705 are energized to, by virtue of the polarization and the manipulations of the crystals of the LCD to block the passage of light thus, in effect, shuttering off the view of the first display 703 for those portions. Preferably any backlighting provided by the lights 200 is discontinued for the associated “shuttered” portions of the second display 701. The video component 702 for those portions is controlled to display video images over the shuttered portions.

In one embodiment the second display 701 is controlled to selectively “shutter” portions of the first display 703 such as, for example, a selected reel 704. In another embodiment the second display 701 is controlled to allow a player to see through the whole of the second display 701 to see the first display 703 behind it. It can therefore be seen that the second display 701 overlays the mechanically operable first display 703 and that the second display 701 may be controlled to be substantially transparent over a whole of the active area of the first display 703. In other words, the second display 701 does not have discreet areas or windows that are transparent, as in the prior art, where the back reflective coating layer is physically removed from a portion of the LCD display panel to allow the underlying mechanical game components to be viewed. In the examples shown herein, the whole of the active area of the second display 701 is available for presenting electronically controlled images to the player. In addition, because there is uniformity of the second display 701 by not having a back reflective layer, it is possible to control the picture brightness contrast and clarity experiences relative to the prior art so that they are uniform over the whole of the second display 701.

The shutter component 705 is positioned between the video component 702 and the mechanical first display 703. The shutter component 705 is transitionable between closed and open viewing states. In other words, the shutter component 705 can act to block viewing through the second display 701 to the mechanical first display 703. In the open viewing state, a player can view through the transparent second display 701 and view the underlying mechanical first display 703. In the embodiment disclosed, the shutter component 705 can comprise any form of shutter. One example comprises a polarisable crystal optical film which is operable when actuated to change polarisation. It is known that light can pass through liquid crystal display panels and that when an electric potential is applied to the film there can be selective polarisation of the crystals to block and/or transmit polarised light therethrough. Thus, in some examples, the shutter component 705 may comprise liquid crystal films incorporated on a rear face of the LCD video component 702. In other examples, to be described hereinafter, the shutter 705 may comprise a blind or panels that are opened or closed.

Accordingly, a second display 701 may be provided as a unit for installation into a gaming machine or the like. The basic form of the second display 701 can comprise a video component 720 and the shutter component 705 together with any related electrical circuits and/or controlling devices. It should be appreciated that the second display 701 will allow full-screen viewing of images on the video component 702 whilst, in a different configuration allowing viewing of the underlying mechanical game components being the reels 704.

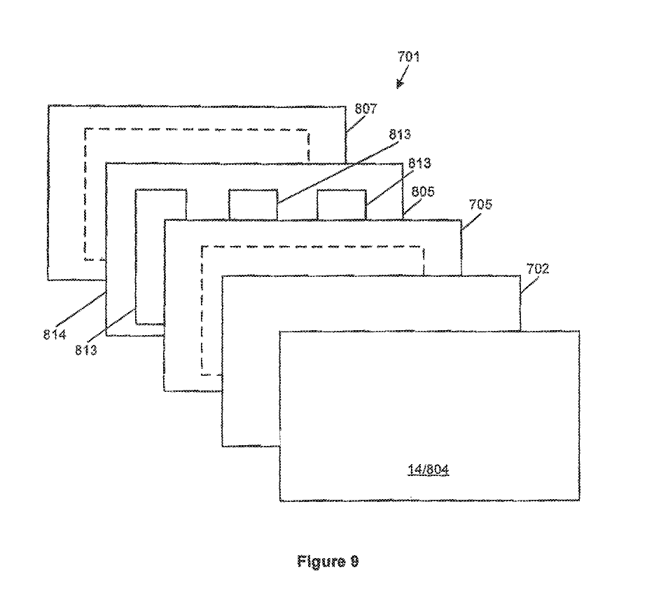

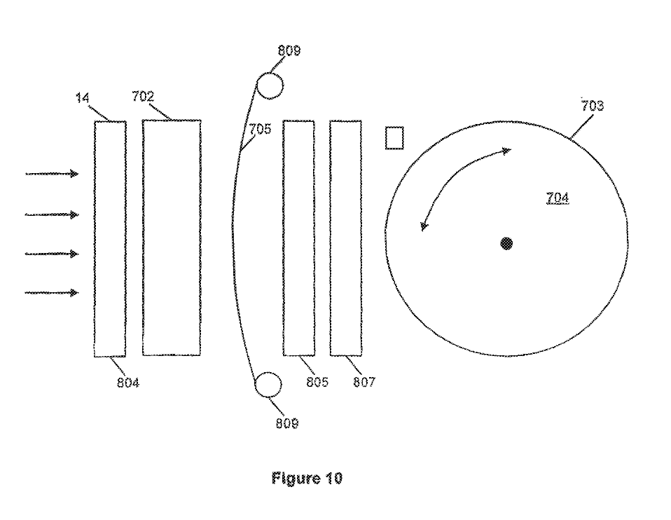

FIG. 8 shows an alternative to the embodiment in FIG. 7 but where like components are shown with the same numerical designations. In this example, the second display 701 is provided with a transparent front protective panel 14 that may be of glass or acrylic to enable viewing of the underlying second display 701 and the reels 704. The transparent protective panel 14 may, in one example, be formed as a touch screen panel 804 so there can player interaction on the touch screen to interact with game play, as is known in the art with touch screen gaming machines. In this case, if the transparent panel 14 is a touch screen itself, then a further front protective panel which is transparent or semi transparent may not be required. FIG. 8 additionally shows a mask 805 positioned between the shutter component 705 and the first display 703. The mask 805 is provided with cut-outs (see FIG. 9 to be referred to later) to permit viewing of the reels 704 of the first display 703. These cut-outs may be sized and shaped to allow only an intended viewable part of the reels 704 such as to provide particular sized and shaped windows to enable only an underlying and aligned marking or indicia on the reels 704 to be viewed there through. This, in turn, conceals unintended viewing of parts of the first display 703 such as unintended markings or indicia, or side regions or side faces of the reels 704, or spaces between the reels 740 to be viewed. The cut-outs or windows may correspond in number and position to the required positions on the reels 704.

In an alternative arrangement, the shutter may comprise multiple shutter components that coincide with intended viewable parts of respective reels 704 and wherein the multiple areas are selectively transitionable between closed and open viewing states to selectively enable required ones or required parts of each of the intended viewable parts to be viewed or not viewed by a player. This may be under electronic control from the controller 100. In a further example, there may be a single shutter area coinciding with intended viewable parts of the first display 703 wherein the single area is transitionable between closed and open viewing states to enable all of the intended viewable parts to be not viewed when in a closed viewing state or to be viewed when in an open viewing state. In a typical embodiment such as that shown in FIG. 7, the shutter component 705 will have an area that is at least as large as and of the same dimension as the whole of the active area of the video component 702 and positioned to coincide therewith. In other examples there may be individual shutter components or a size and shape to correspond with the respective intended viewing areas of the reels 704.

FIG. 8 also shows the use of a back light panel 807 which can be self illuminating or can be illuminated from side regions to illuminate the respective reels 704 to assist in easy viewing of the reels 704. Typically, the back light 807 has a cut-out therein of sufficient size to surround the perimeter of all of the reels 704, or each of the reels 704 (i.e. with a plurality of cut-outs). Typically, the back light panel comprises a light transmitting panel such as of glass or acrylic or the like which is illuminated from side edges. The light will then pass through the material towards the cut-outs and then be dispersed onto the reels 704 to illuminate the reels 704 and permit easy viewing through the display screen 702.

FIG. 9 shows an exploded top perspective view in diagrammatic form of each of the components on the second display 701. Each of the panels are of approximately the same dimensions and overlay each other. At the front face (i.e. the face directed towards the viewer) there is provided the touch screen 804 or the transparent panel 14. Immediately behind that panel is the video component 702 in the form of a transparent liquid crystal display (LCD). Here, the whole of the active area of the video component 702 is available for providing images to the player. Immediately behind the video component 702 is provided a shutter component 705. The shutter component 705 is of the type that can be transitionable between open and closed states so that the underlying first display 703, such as reels 704, can be viewed. In one example, the shutter component 705 is an LCD type screen film that can have an electrical voltage applied thereto to cause the crystals therein to be nonaligned and thus be non-transparent. Upon the application of an opposite polarity or different voltage, the shutter component 705 can transition so that the crystals align and allow the passage of light. This, in turn, will cause the shutter component 705 to become transparent or semi-transparent. Mounted behind the shutter 705 is the non transparent mask 805 which may be formed from metal, glass or other suitable opaque material. The mask 805 has cut-outs 813 that have an area and shape to permit required areas on the reels 704 to be viewed. The mask 805 acts to inhibit viewing of other parts or unwanted viewing parts of the first display 703 such as side edge faces of the reels or other unintended sections of the periphery of the reels 704. Whilst individual cut-outs 813 have been shown, there may be provided larger shaped cut-outs to encompass two or more of the intended viewing areas of the reels 704. Mounted behind the mask 805 is provided the backlight panel 807 for illuminating the reels 704.

The whole of the second display 701 may be arranged to have a relative compact thickness configuration so that each of the components are butt aligned with one another in co-planar abutting relationship. Appropriate electrical connections can be made to the various components so that the second display 701 can be operated from the processor under control of program code executed by the processor to provide a video game on the video component 702.

FIG. 10 is an embodiment similar to that shown in FIG. 8 where like components have been provided with like numerical designations. In this embodiment, the shutter component 705 is like a physical blind curtain that can move across the rear of the video display 702 to permit viewing of the underlying reels 704 or to inhibit the viewing of the underlying reel 704. In this case, the shutter component 705 is in the form of a blind which can be wound onto and off blind rollers 809. One or both of the blind rollers 809 may be electrically motor driven for causing the shutter component 705 to be opened and/or closed.

In an alternative arrangement the shutter component 705 may be comprised of one or more non transparent panels that are moved to enable the shutter curtain to be open or closed.

It should be appreciated that by using the above second display 701 in a gaming machine, that the processor in the gaming machine can be used for controlling game play either via the video game component or the mechanical game component or both. In addition, the display screen 702 may be able to provide display of meters 104 for information concerning wagering and game outcome results to the player. A game sequence may be initiated from the processor for game play either on the mechanical game component 703 or the video game component. Accordingly, in some cases a mechanical game can be played and when a certain outcome is achieved, then a bonus or feature game can be played on the video screen 702. Game play may be first initiated via the display screen 702 and then on the mechanical game component consequent on a certain outcome in the video game component, or alternatively first on the mechanical game component and then on the video game component. In other embodiments, game play can take place solely on the video game component on the display screen 702, or on the mechanical game component 703. In addition a multi-game machine may be provided where the player can select from a plurality of possible different games. The multi-game machine may have the possibility to play either the video game component, or the mechanical game component, or a game, or a plurality of games, that are a combination of both the video game component and the mechanical game component.

It is to be understood that, if any prior art publication is referred to herein, such reference does not constitute an admission that the publication forms a part of the common general knowledge in the art, in Australia or any other country.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A gaming machine, comprising:
a mechanically operable game component and a video operable game component, at least said video operable game component being operable by a processor in response to program code executed by said processor to provide a video game on a display screen of the said video operable game component,
said display screen overlaying said mechanically operable game component, being transparent over a whole of an active area of said display screen, and wherein the whole of the active area of said display screen is useable to display the video game thereon,
a shutter positioned between said display screen and said mechanically operable game component, said shutter being changeable between closed and open viewing states, and wherein in a closed viewing state said mechanically operable game component cannot be viewed by a player through said display screen, and wherein in an open viewing state said mechanically operable game component can be viewed by a player through said display screen.

2. A gaming machine as claimed in claim 1, comprising a reel framing curtain between said display screen and said shutter and operable when said shutter is in an open viewable state to enable player viewing of intended viewable parts of the mechanically operable game component and to inhibit player viewing of parts not intended to be viewed.

3. A gaming machine as claimed in claim 1, wherein said shutter has multiple areas coinciding with the intended viewable parts of the mechanically operable game component and wherein said multiple areas are selectively changeable between closed and open viewing states to selectively enable required ones or required parts of each of the intended viewable parts to be not viewed or to be viewed by a player.

4. A gaming machine as claimed in claim 1, wherein said shutter has an area at least as large as and of the same dimensions as the whole of the active area of the display screen and positioned to coincide therewith.

5. A gaming machine as claimed in claim 1, wherein said display screen is a LCD display screen.

6. A gaming machine as claimed in claim 1, comprising meters for indicating game information to a player, said meters being controllable from said processor, and wherein said meters are displayed on said display screen.

7. A gaming machine as claimed in claim 1, wherein game outcomes from said mechanical game component are processable by said processor together with game outcomes from said video operable game component, and wherein said outcomes are displayable on said display screen.

8. A gaming machine as claimed in claim 1, wherein said mechanical game component comprises a plurality of reel assemblies, each comprising a reel and a motor to drive the wheel for rotation, said processor being able to control each said motor to rotate and position said reels during game play.

9. A display device for a gaming machine, said display device comprising:
a video operable game component, being operable from a processor in response to program code executable by said processor to provide a video game on a display screen thereof,
said display screen being for overlaying a mechanically operable game component and being transparent over a whole of the active area of said display screen and wherein the whole of the active area of said display screen is useable to display the video game thereon,
a shutter for positioning between said display screen and said mechanically operable game component, said shutter being changeable between closed and open viewing states, and wherein, in use, in a closed viewing state said mechanically operable game component cannot be viewed by a player through said display screen, and wherein in an open viewing state said mechanically operable game component can be viewed by a player through said display screen.

10. A display device as claimed in claim 9 comprising a reel framing curtain between said display screen and said shutter and operable when said shutter is in an open viewable state to enable player viewing of intended viewable parts of the mechanically operable game component and to inhibit player viewing of parts not intended to be viewed.

11. A display device as claimed in claim 10, wherein said shutter has multiple areas for coinciding with the intended viewable parts of the mechanically operable game component and wherein said multiple areas are selectively changeable between closed and open viewing states to selectively enable required ones or required parts of each of the intended viewable parts to be not viewed or to be viewed by a player.

12. A display device as claimed in claim 9, wherein said shutter has an area at least as large as and of the same dimensions as the whole of the active area of the display screen and positionable to coincide therewith.

13. A display device as claimed in claim 9, wherein said display screen is a LCD display screen.

14. A display device as claimed in claim 9, comprising meters for indicating game information to a player, said meters being controllable from said processor, and wherein said meters are displayed on said display screen.

15. A display device as claimed in claim 9, wherein game outcomes from said mechanical game component are processable by said processor together with game outcomes from said video operable game component, and wherein said outcomes are displayable on said display screen.

16. A gaming machine comprising:
a first display configured to display images for the play of a game;
a second display overlaying at least a portion of said first display, said second display including a video display component configured to display images for the play of the game and a shutter component, said video display component and shutter component being operable between a first condition where said second display is substantially transparent for viewing of said first display and the images displayed thereat and a second condition where said shutter component is substantially opaque to viewing of at least a portion of said first display; and
a processor to control the first and second displays to display for viewing images of said first display when said second display is in said first condition or images of said second display when said second display is in said second condition.

17. The gaming machine of claim 16, wherein said second display overlays substantially the entire first display.

18. The gaming machine of claim 16, comprising a mask disposed between said first and second displays.

19. The gaming machine of claim 16, wherein said first display is a plurality of electro-mechanical reels to display game symbols.

20. The gaming machine of claim 19, comprising a mask displaced between said first display and said second display, said mask covering from viewing at least a portion of said first display.

21. The gaming machine of claim 19, comprising a light for at least one of said reels, said processor configured to operate said light from an ON state to light said reel when said second display is in said first condition and to operate said light to an OFF state when said second display is in said second condition.
